(19) United States
(12) Patent Application Publication
(10) Pub. No.: US 2017/0168523 A1
(43) Pub. Date: Jun. 15, 2017

(54) BISTABLE WEARABLE COMPUTING DEVICE

(71) Applicant: Arya A. Ardakani, Mission Viejo, CA (US)

(72) Inventor: Arya A. Ardakani, Mission Viejo, CA (US)

(21) Appl. No.: 15/380,830

(22) Filed: Dec. 15, 2016

Related U.S. Application Data
(60) Provisional application No. 62/267,829, filed on Dec. 15, 2015.

(51) Int. Cl. G06F 1/16; H04B 1/3827; H02J 50/10; H02J 7/00; H02J 7/02

(52) U.S. Cl. CPC G06F 1/163; G06F 1/1698; G06F 1/1635; H02J 7/0052; H02J 7/025; H02J 50/10; H04B 1/385; H02J 2007/0062

(57) ABSTRACT

The subject technology encompasses a wearable computing device configured to be conveniently worn around a user's wrist. In some aspects, the wearable computing device can include a bistable housing configured to be mechanically stable in each of a first mechanical configuration and a second mechanical configuration, and a mobile computing device mechanically coupled to the bistable housing.

### CROSS-REFERENCE TO RELATED APPLICATIONS

This application claims the benefit of U.S. Provisional Application No. 62/267,829 filed on Dec. 15, 2015, and entitled “BISTABLE WEARABLE COMPUTING DEVICE”, which is incorporated by reference in its entirety.

### BACKGROUND

1. Technical Field

The subject technology relates to a wearable computing device and in particular, a computing device embedded in a bi-stable chassis to facilitate convenient placement and removal by a user.

2. Introduction

As computer processing and storage devices become more powerful, the miniaturization of computing hardware has enhanced the portability of various electronic devices.

### SUMMARY

Aspects of the subject technology relate to a mobile computing device disposed within a bistable chassis that can be adapted for various functions. In some aspects, the computing device can be configured to function as a mobile media player capable of playing/displaying audio and/or video content. By way of example, the mobile computing device may include a MP3 player, for example, that can play music (on device), or that can communicate audio signals to a separate audio device (e.g., headset or speakers), using a radio frequency (RF) communication means, such as Bluetooth®.

In other aspects, the computing device can include a display/indicator, such as a LED, LCD, organic LED (OLED), or capacitive touch screen, configured to playback video content stored on a storage medium of the wearable computing device.

In other aspects, the computing device can include one or more sensors, such as pedometers, accelerometers, gyroscopes, global positioning systems (GPS) modules, and/or heart rate sensors, etc., that can be used to collect user information. By way of example, using one or more of the affirmation sensors, the wearable computing device could be configured to track a number of steps taken by a user, and activity type that is being engaged by the user, and/or activity level of the user.

It is understood that other configurations of the technology will become readily apparent to those skilled in the art from the following detailed description, wherein various configurations of the subject technology are shown and described by way of illustration. The subject technology is capable of other and different configurations and its several details are capable of modification in various respects without departing from the scope of the subject technology. Accordingly, the detailed description and drawings are to be regarded as illustrative and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1A illustrates a perspective view of a wearable computing device, according to some aspects of the subject technology.

FIG. 1B illustrates an example of a wearable computing device worn by a user, according to some aspects.

FIG. 2 displays a cross-section view of an example wearable computing device, including example component parts that can be used to implement a mobile computer, according to some aspects.

FIG. 3A illustrates an example of component part placement on a bistable housing structure, according to some aspects.

FIG. 3B illustrates a cross section view of the example component part arrangement provided by the example of FIG. 3A.

FIG. 4 illustrates an example layout for various components used to implement a wearable computing device.

FIG. 5 illustrates an example arrangement of circuit connectivity, according to some aspects of the technology.

FIG. 6 illustrates an exploded view of various layers that can be used to implement a wearable computing device.

FIG. 7A illustrates an example of a bistable housing for a wearable computing device that includes two bistable spring structures.

FIG. 7B illustrates a cross sectional view of an example computing device, according to various aspects of the technology.

FIG. 8 illustrates an example block diagram of circuit components that can be used to implement a bistable computing device of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

The bistable computing device can include electrical components and software configured to operate as a digital media player (e.g., a music or video player). For example, in some aspects, the bistable computing device can include one or more memory components, one or more microprocessors, and one or more radio communication devices, e.g., a Bluetooth Low Energy (BLE) device, etc. In some aspects, communication componentry (e.g., a BLE chipset) can be used to facilitate communication with other computing devices or audio output devices, such as wireless headphones.

Wireless communication can facilitate the transfer of commands, e.g., between the bistable computing device and a host system, such as a mobile computer or smart phone. For example, for downloading data such as media content and/or software updates to the bistable computing device. Wireless communication can also enable the transfer of data, such as music, stored on a device memory of the bistable computer, for example to a wireless headset or speaker system.

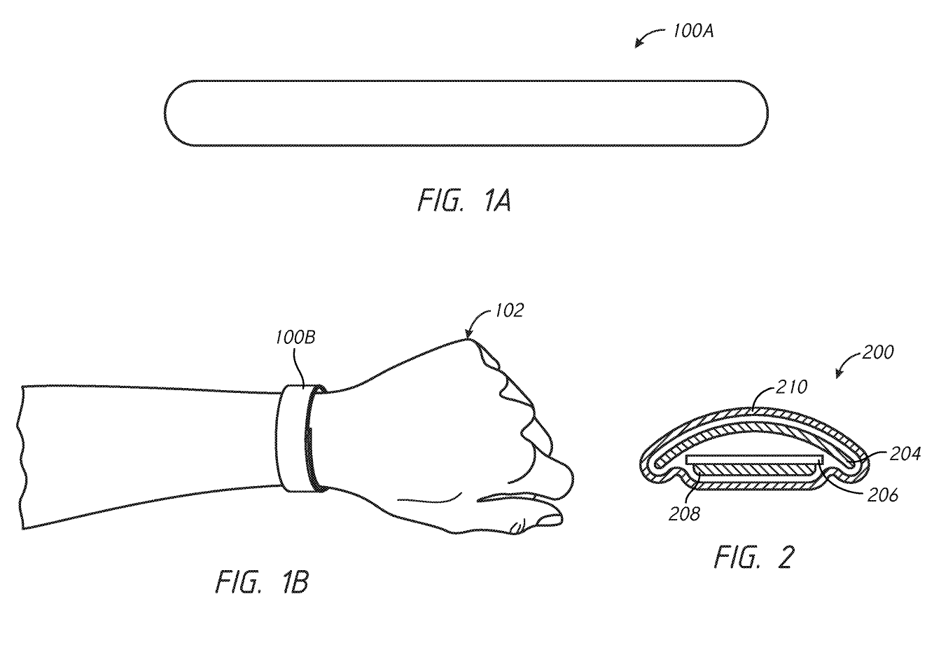

FIG. 1A illustrates a perspective view of a bistable computing device 100A, according to some aspects of the technology. Bistable computing device (e.g., wearable device) 100A is illustrated in a first mechanical configuration, for example, in which a bistable housing (chassis) of wearable device 100A is extended in a linear configuration. As discussed above, a housing of wearable device 100A can be flexible and capable of being mechanically deformed into other orientations. For example, wearable device 100A can be formed into other mechanically stable configurations, such as coiled configuration, as illustrated with respect to FIG. 1B.

FIG. 1B illustrates an example of wearable computing device 100B worn by user 102. In this example, wearable computing device 100B is configured in a second mechanical configuration, e.g., in a coiled configuration around a wrist of user 102. Although computing device 100B is illustrated as being worn on the wrist of user 102, is understood that other placement options are available, without departing from the scope of the technology. For example, in a coiled configuration, wearable computing device 100B can be placed around any other acceptable portion of the body, e.g., a user's ankle, upper arm, neck, or leg, etc.

Additionally, a coiled configuration can be used to place wearable computing device 100B around other objects or articles of clothing, such as a backpack, or belt loop, etc.

FIG. 2 displays a cross-section view of an example wearable computing device 200, including example component parts that can be used to implement a mobile computer. In the example of FIG. 2, various component parts of wearable computing device 200 are illustrated, for example, which include: bistable spring 204, printed circuit board (PCB) 206, circuit components 208, and covering 210.

In practice, bistable spring 204 is responsible for providing rigidity in form to wearable computing device 200. As discussed above, bistable spring 204 can be mechanically stable in multiple configurations, such as a linear or elongate configuration (as described above with respect to FIG. 1A), or a coiled configuration (as discussed above with respect to FIG. 1 B).

Covering 210 can be used to enclose bistable spring 204 and PCB 206 (together with circuit components 208), forming the housing of mobile computing device 200. In some aspects, covering 210 can include various fabric types, such as, but not limited to: polyester, plastic, and/or cotton blends, etc. Additionally, in the illustrated configuration, covering 210 provides mechanical support to PCB 206 and circuit components 208, for example, which hold the same against a surface of bistable spring 204. However, as discussed below, other configurations for PCB 206 and circuit components 208 can be implemented without departing from the technology.

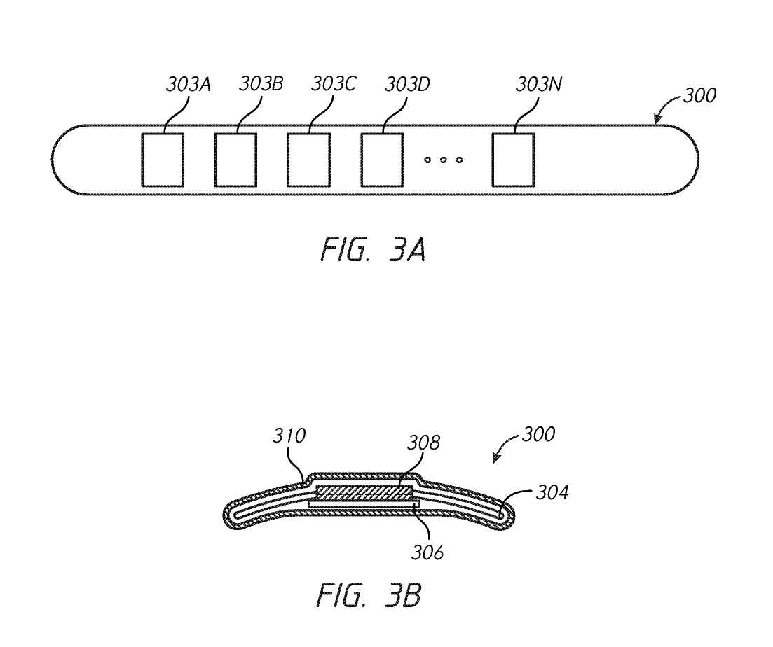

FIG. 3A illustrates an example component part placement with respect to a bistable housing structure 300. In the example of FIG. 3A, bistable housing structure (e.g., bistable spring) 300 includes a multitude of apertures (holes) 303_{A}-303_{N} disposed within a surface of the bistable spring 300. Apertures 303_{A}-303_{N} can permit interior placement of various component parts such as PCBs and/or chips, into bistable spring 300, thus reducing an overall thickness of the device.

FIG. 3B illustrates a cross section view of a wearable computing device 300, with the example component part arrangement provided by the example of FIG. 3A. As illustrated, PCB 306 and chips/component parts 308 are disposed within bistable spring 304 that, in turn, is surrounded by covering 310. As mentioned above, such configurations can reduce an overall thickness of the wearable computing device 300, which may be preferential for users wearing the device, for example, about their wrist or ankle.

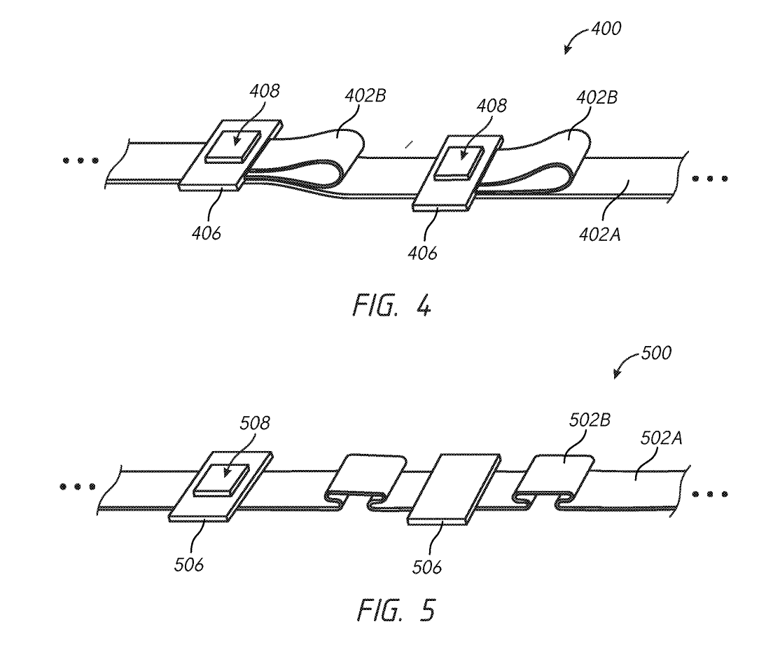

FIG. 4 illustrates an example circuit design 400 for various components used to implement a wearable computing device, according to some aspects of the technology. Circuit design 400 includes use of a flex cable 402A, service loops 402B, PCBs 406, and circuit components 408.

In practice, flex cable 402A can be used to provide a flexible electrical connection between various PCBs 406, which permits transitions of the bistable housing from a first mechanical configuration (e.g., an extended or linear configuration) into a second mechanical configuration (e.g., a coiled configuration). Service loops 402B can be used to provide an extra length for neatness of assembly, accessibility, and/or freedom of movement.

FIG. 5 illustrates an example arrangement of circuit connectivity, including service loops 502B, according to some aspects of the technology. Although FIGS. 4 and 5 illustrate two circuit layouts for the respective PCBs, components parts, and flex cables/service loops, it is understood that other configurations can be implemented, without departing from the technology.

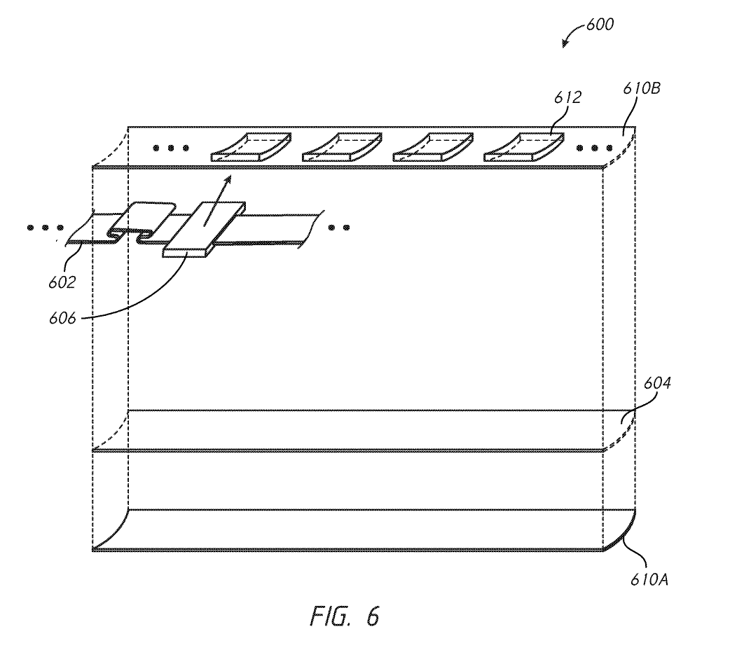

FIG. 6 illustrates an exploded view of various layers 600 used to construct a wearable computing device, according to some aspects. Layers 600 include covering layers 610A and 610B. As discussed above, covering layers 610A/B can comprise different materials or fabric types. Additionally, in the illustrated example, covering layer 610B includes pockets 612 configured to facilitate the securement of various chips/PCBs of the mobile computing device, such as PCBs 606. When assembled, covering layer 610A covers a bottom surface of bistable spring 604 that resides beneath various PCBs/chips 606 of the wearable computing device. In turn covering layer 610B, including pockets 612, secures a top surface of the mobile computing device.

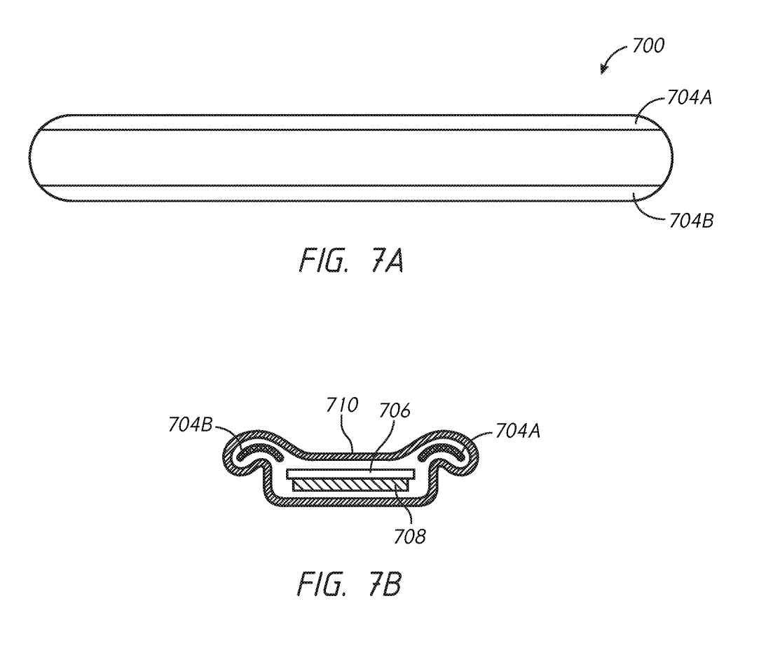

FIG. 7A illustrates an example of a bistable housing 700 for a wearable computing device that includes two bistable spring structures, e.g., 704A and 704B. Although the bistable housing 700 of FIG. 7A includes two bistable spring structures, it is understood that a greater number of bistable springs can be implemented without departing from the technology. By way of example, three or more bistable structures may be used to construct the bistable housing of the wearable device.

FIG. 7B illustrates an example cross sectional view of wearable computing device 700. As illustrated, PCBs and flex cables 706 support circuit components 708, which are disposed between each of two bistable spring structures, e.g., first bistable spring structure 704A and second bistable spring structure 704B. All component parts (706, 708) and bistable springs (704A, 704B) are enclosed by covering 710.

It is understood that other components and/or PCB arrangements are possible, without departing from the subject technology. For example, FIG. 7 B illustrates an arrangement wherein circuit components 708 are placed below PCB and flex cables 706. However, opposite arrangements are possible, e.g., in which circuit components 708 are disposed above their respective PCB and flex cables 706.

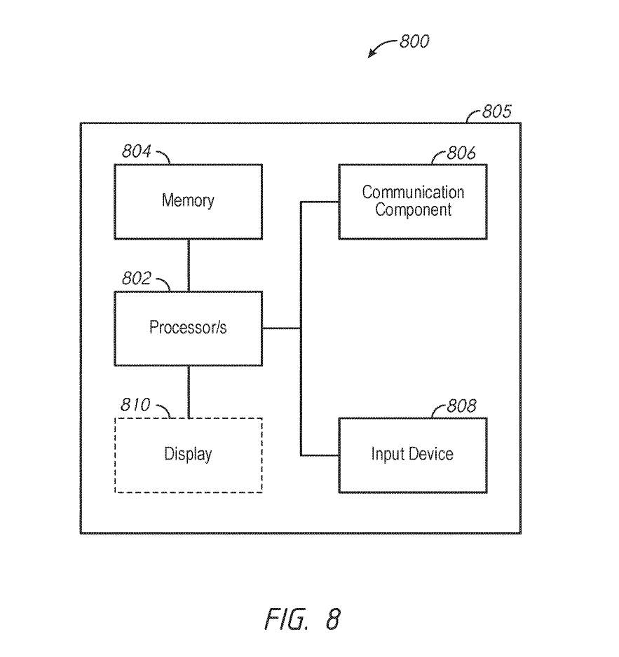

FIG. 8 illustrates an example block diagram of circuit components that can be used to implement a mobile computing device e.g. for use as part of a bistable wearable computing device of the subject technology. Computing device 800 includes processor 802 for executing instructions that can be stored in a memory device or element 804. The instructions can cause computing device 800 to execute computer-implemented methods and/or receive instructions.

As would be apparent to one of ordinary skill in the art, the computing device 800 can include many types of memory, data storage, or non-transitory computer-readable storage media, such as a first data storage for program instructions for execution by the processor 802, a separate storage for usage history or user information, a removable memory for sharing information with other devices, etc. In some embodiments, computing device 800 can include one or more communication component 806, such as a Wi-Fi, Bluetooth®, radio frequency, near-field communication (NFC), wired, and/or wireless communication system. The computing device 800 in many embodiments can communicate with a network, such as a WiFi network with access to the Internet. Using communication component 806, computing device 800 may be able to communicate directly with other devices, e.g., using wireless transmissions, such as Bluetooth®. That is, computing device 800 may communicate directly with other wearable computing devices of a similar type.

Additionally, in some aspects computing device 800 may include a battery module or power module (not illustrated), which can be coupled to one or more of processor/s 802, memory 804, communication component 806, and/or input device 808. The battery module can include one or more power storage cells and/or circuitry needed to store electrical charge and dissipate power necessary to run computing device 800. In some aspects, the battery module may be configured for inductive (wireless) charging, for example, such that a wearable computing device implementing computing device 800 can be wirelessly charged via charging stand or base station. In other aspects, the battery module may be configured for charging via an electrical bus, such as a Universal Serial Bus (USB) port, or the like.

The computing device 800 in many embodiments will include at least one input element 808 able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual, audio and/or motion=based commands. In some aspects computing device 800 may include some type of display element 810, such as a touch screen or liquid crystal display (LCD).

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A wearable computing device, comprising:
a bistable housing configured to be mechanically stable in a first mechanical configuration and a second mechanical configuration; and
a mobile computing device coupled to the bistable housing, wherein the mobile computing device comprises:
one or more processors;
a non-transitory computer-readable storage medium coupled to the one or more processors; and
a network interface module coupled to the one or more processors, the network interface module configured for transacting data with a wireless network.

2. The wearable computing device of claim 1, wherein the bistable housing is configured to be coiled in the first mechanical configuration.

3. The wearable computing device of claim 1, wherein the bistable housing is configured to be fixed in a linear orientation in the second mechanical configuration.

4. The wearable computing device of claim 1, wherein the mobile computing device is mechanically bound to an outer surface of the bistable housing.

5. The wearable computing device of claim 1, wherein the mobile computing device is disposed within an aperture in an outer surface of the bistable housing.

6. The wearable computing device of claim 1, wherein the one or more processors are communicatively coupled to the storage medium via a flex cable.

7. The wearable computing device of claim 1, wherein the one or more processors are communicatively coupled to the network interface module via a flex cable.

8. The wearable computing device of claim 1, wherein the storage medium comprises one or more flash memory cells.

9. The wearable computing device of claim 1, wherein the network interface module comprises a wireless transmitter.

10. The wearable computing device of claim 1, further comprising:
a battery unit electrically coupled to the one or more processors, the storage medium, and the network interface module, and
wherein the battery unit is configured to be charged through an inductive coupling.

11. The wearable computing device of claim 1, further comprising:
a battery unit electrically coupled to the one or more processors, the storage medium, and the network interface module, and
wherein the battery unit is configured to be charged through a Universal Serial Bus (USB) interface.

12. The wearable computing device of claim 1, wherein the bistable housing is configured to be disposed around a user's wrist in the first mechanical configuration.

13. The wearable computing device of claim 1, wherein the bistable housing is configured to be disposed around a user's ankle in the first mechanical configuration.

14. The wearable computing device of claim 1, wherein the bistable housing comprises a single bistable spring structure.

15. The wearable computing device of claim 1, wherein the bistable housing comprises two or more bistable spring structures.

16. A wearable computing device, comprising:
a housing comprising two bistable spring structures, the two bistable spring structures disposed in a parallel configuration and configured to be disposed in a first mechanical configuration and a second mechanical configuration
a mobile computing device coupled to the bistable housing, wherein the mobile computing device comprises:
one or more processors;
a non-transitory computer-readable storage medium coupled to the one or more processors; and
a network interface module coupled to the one or more processors, the network interface module configured for transacting data with a wireless network.

17. The wearable computing device of claim 16, wherein the two bistable spring structures are configured to be coiled in the first mechanical configuration.

18. The wearable computing device of claim 16, wherein the two bistable spring structures are configured to be fixed in a linear orientation in the second mechanical configuration.

19. The wearable computing device of claim 16, wherein the mobile computing device is mechanically bound to an outer surface of the bistable housing formed between the two bistable spring structures.

20. The wearable computing device of claim 16, wherein the mobile computing device is disposed within an aperture formed between the two bistable spring structures.
